(19) United States
(12) Patent Application Publication
(10) Pub. No.: US 2017/0308155 A1
(43) Pub. Date: Oct. 26, 2017

(54) POWER CONSUMPTION MANAGEMENT METHOD AND DEVICE AND COMPUTER STORAGE MEDIUM

(71) Applicant: Sanechips Technology Co., Ltd., Shenzhen, Guangdong (CN)

(72) Inventors: Haitao Lu, Shenzhen (CN); Yingjie An, Shenzhen (CN); Wei Wang, Shenzhen (CN)

(21) Appl. No.: 15/517,668

(22) PCT Filed: May 27, 2015
(86) PCT No.: PCT/CN2015/079927

§ 371 Date: Apr. 7, 2017

(30) Foreign Application Priority Data
Oct. 17, 2014 (CN) 201410554982.9

(51) Int. Cl. G06F 1/32

(52) U.S. Cl. CPC G06F 1/3296; G06F 1/3215; G06F 1/3287

(57) ABSTRACT

A power consumption management method and a power consumption management device are provided, wherein the method comprises: setting at least two levels of power consumption management units; acquiring, by an upper-level power consumption management unit, power consumption management related information of a lower-level power consumption management unit (11); and performing, by the upper-level power consumption management unit, power consumption management on the lower-level power consumption management unit according to the acquired information and a preset power consumption management policy (12). This scheme can perform power consumption control in particular to a kernel and/or a peripheral level, so as to achieve flexibility and have a better power saving effect.

### TECHNICAL FIELD

The disclosure relates to the field of wireless communication technologies, and in particular to a power consumption management method and device and a computer storage medium.

### BACKGROUND

In a mobile communication system, handheld terminal products are usually very power-consuming, and short standby time caused by the power consumption problem seriously impacts the experiences of users. Therefore, how to effectively reduce the power consumption of the products is a technical problem to be solved for a long time.

Terminal chip serves as an important part of a terminal product, and the low-power consumption implementation policy of the terminal chip has a deep influence on the final product power consumption data; that is to say, if there is no effective low-power consumption technology implemented on the terminal chip, any other low-power consumption method based on the complete machine product is imperfect.

Low-power consumption design techniques mainly adopted in system design and implementation of a chip are as follows.

(1) Clock Gating;

(2) Power Gating;

(3) Multi-Supply Voltage;

(4) Dynamic Voltage Frequency Scale; and

(5) Multi-Vt Synthesis

The above techniques have more or less been used in various mobile phone terminal products, to improve the power consumption performance of the products. However, current power consumption control technologies applied to chips are coarse in control granularity, and cannot perform power consumption control in a particular level of kernel and/or peripheral, thus causing inflexible implementation and poor power saving effect.

### SUMMARY

In view of this, in order to solve the existing technical problem, a power consumption management method, a power consumption management device and a computer storage medium are provided in embodiments of the disclosure.

An embodiment of the disclosure provides a power consumption management method, which is applied to a terminal chip, in which at least two levels of power consumption management units are provided; the method includes the steps that an upper-level power consumption management unit acquires power consumption management related information of a lower-level power consumption management unit; and the upper-level power consumption management unit performs power consumption management on the lower-level power consumption management unit according to the acquired information and a preset power consumption management policy.

In a specific embodiment, a first-level power consumption management unit, at least one second-level power consumption management unit and at least one third-power consumption management unit are provided. The first-level power consumption management unit performs power consumption management on the second-level power consumption management unit; the second-level power consumption management unit performs power consumption management on the third-level power consumption management unit; and the third-level power consumption management unit performs power consumption management on a peripheral of the terminal.

In a specific embodiment, the second-level power consumption management unit includes at least one of a baseband processing subsystem power consumption management unit, an application processing subsystem power consumption management unit and an audio subsystem power consumption management unit. The baseband processing subsystem power consumption management unit is responsible for power consumption management related to communication control and data processing inside the terminal chip; the application processing subsystem power consumption management unit is responsible for power consumption management related to control and data processing of the application processing subsystem inside the terminal chip; and the audio subsystem power consumption management unit is responsible for power consumption management related to audio control and data processing inside the terminal chip.

In a specific embodiment, the second-level power consumption management unit includes a baseband processing subsystem power consumption management unit and an application processing subsystem power consumption management unit. The third-level power consumption management unit under the baseband processing subsystem power consumption management unit includes at least one of a protocol stack kernel unit and a physical layer kernel unit; and the third-level power consumption management unit under the application processing subsystem power consumption management unit includes at least one of an application processor kernel unit and an audio kernel unit.

The embodiment of the disclosure further provides a power consumption management device, which is provided in a terminal chip and includes: a first-level power consumption management unit, at least one second-level power consumption management unit and at least one third-power consumption management unit. The first-level power consumption management unit is arranged to acquire power consumption management related information of the second-level power consumption management unit and to perform power consumption management on the second-level power consumption management unit according to the acquired information and a preset power consumption management policy; and the second-level power consumption management unit is arranged to acquire power consumption management related information of the third-level power consumption management unit and to perform power consumption management on the third-level power consumption management unit according to the acquired information and a preset power consumption management policy.

In a specific embodiment, the second-level power consumption management unit includes at least one of a baseband processing subsystem power consumption management unit, an application processing subsystem power consumption management unit and an audio subsystem power consumption management unit; the baseband processing subsystem power consumption management unit is responsible for power consumption management related to communication control and data processing inside the terminal chip; the application processing subsystem power consumption management unit is responsible for power consumption management related to control and data processing of the application processing subsystem inside the terminal chip; and the audio subsystem power consumption management unit is responsible for power consumption management related to audio control and data processing inside the terminal chip.

In a specific embodiment, the second-level power consumption management unit includes a baseband processing subsystem power consumption management unit and an application processing subsystem power consumption management unit. The third-level power consumption management unit under the baseband processing subsystem power consumption management unit includes at least one of a protocol stack kernel unit and a physical layer kernel unit; and the third-level power consumption management unit under the application processing subsystem power consumption management unit includes at least one of an application processor kernel unit and an audio kernel unit.

The embodiment of the disclosure further provides a computer storage medium, including a set of computer executable instructions for executing the power management method described in the embodiment of the disclosure.

According to the power consumption management method and device and the computer storage medium described in the embodiments of the disclosure, at least two levels of power consumption management units are provided, the upper-level power consumption management unit acquires power consumption management related information of the lower-level power consumption management unit, and the upper-level power consumption management unit performs power consumption management on the lower-level power consumption management unit according to the acquired information and a preset power consumption management policy. The technical scheme descried in the embodiment of the disclosure can perform power consumption control in particular level of kernel and/or peripheral, so as to achieve flexibility and have a better power saving effect.

### BRIEF DESCRIPTION OF THE DRAWINGS

FIG. 1 is a flowchart of a power consumption management method according to an embodiment of the disclosure;

FIG. 2 is a structure diagram of a power consumption management device according to the embodiment of the disclosure;

FIG. 3 is a hierarchical diagram of the System-On-Chip (SOC) low-power consumption management in Embodiment One of the disclosure;

FIG. 4 is a diagram of a preferred embodiment of the SOC low-power consumption management in Embodiment One of the disclosure;

FIG. 5 is a diagram of an application processing subsystem power consumption management unit (102) and peripherals thereof in Embodiment One of the disclosure;

FIG. 6 is a diagram of a baseband processing subsystem power consumption management unit (101) and peripherals thereof in Embodiment One of the disclosure; and

FIG. 7 is an interconnection relationship diagram among a top-layer power consumption management unit (100), a baseband processing subsystem power consumption management unit (101) and an application processing subsystem power consumption management unit (102) in Embodiment One of the disclosure.

### DETAILED DESCRIPTION

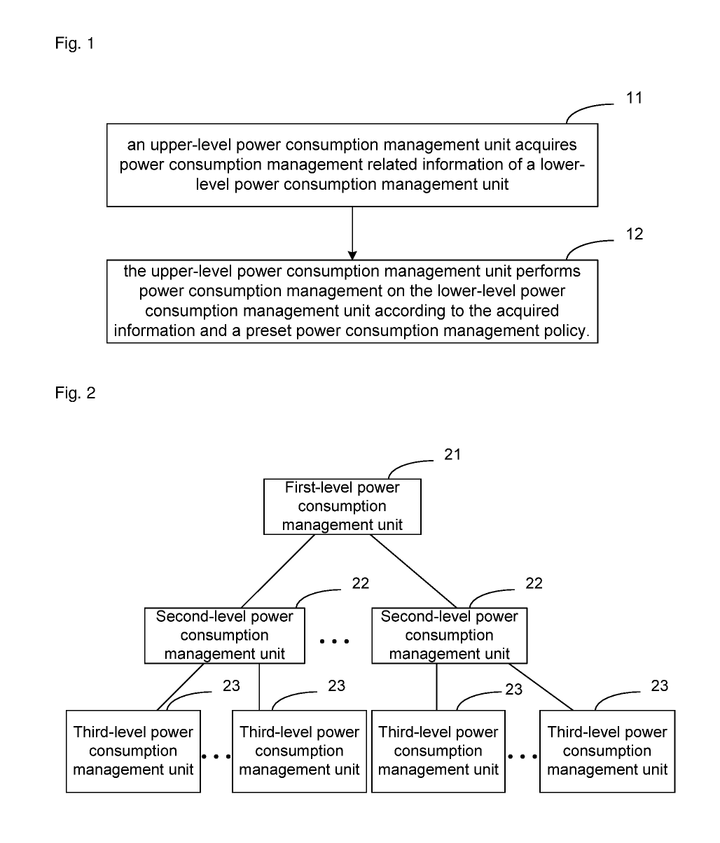

An embodiment of the disclosure provides a power consumption management method, which is applied to a terminal chip. As shown in FIG. 1, the method includes Steps 11 and 12.

In Step 11, an upper-level power consumption management unit acquires power consumption management related information of a lower-level power consumption management unit.

In order to implement the embodiment of the disclosure, at least two levels of power consumption management units are provided correspondingly.

In Step 12, the upper-level power consumption management unit performs power consumption management on the lower-level power consumption management unit according to the acquired information and a preset power consumption management policy.

In an embodiment of the disclosure, a first-level power consumption management unit, at least one second-level power consumption management unit and at least one third-power consumption management unit are provided.

The first-level power consumption management unit performs power consumption management on the second-level power consumption management unit.

The second-level power consumption management unit performs power consumption management on the third-level power consumption management unit.

The third-level power consumption management unit performs power consumption management on a peripheral of the terminal.

In an embodiment of the disclosure, the second-level power consumption management unit includes at least one of a baseband processing subsystem power consumption management unit, an application processing subsystem power consumption management unit and an audio subsystem power consumption management unit.

The baseband processing subsystem power consumption management unit is responsible for power consumption management related to communication control and data processing inside the terminal chip.

The application processing subsystem power consumption management unit is responsible for power consumption management related to control and data processing of the application processing subsystem inside the terminal chip.

The audio subsystem power consumption management unit is responsible for power consumption management related to audio control and data processing inside the terminal chip.

In an embodiment of the disclosure, the second-level power consumption management unit includes a baseband processing subsystem power consumption management unit and an application processing subsystem power consumption management unit.

Accordingly, the third-level power consumption management unit under the baseband processing subsystem power consumption management unit includes at least one of a protocol stack kernel unit and a physical layer kernel unit.

The third-level power consumption management unit under the application processing subsystem power consumption management unit includes at least one of an application processor kernel unit and an audio kernel unit.

In an embodiment of the disclosure, the second-level power consumption management unit includes the baseband processing subsystem power consumption management unit, the application processing subsystem power consumption management unit and the audio subsystem power consumption management unit at the same time; then, the third-level power consumption management unit under the application processing subsystem power consumption management unit merely includes the application processor kernel unit, and the audio kernel unit becomes the third-level power consumption management unit under the audio subsystem power consumption management unit.

The embodiment of the disclosure further provides a power consumption management device correspondingly, which is provided in a terminal chip; as shown in FIG. 2, the device includes: a first-level power consumption management unit 21, at least one second-level power consumption management unit 22 and at least one third-power consumption management unit 23.

The first-level power consumption management unit 21 is arranged to acquire power consumption management related information of the second-level power consumption management unit 22 and to perform power consumption management on the second-level power consumption management unit 22 according to the acquired information and a preset power consumption management policy.

The second-level power consumption management unit 22 is arranged to acquire power consumption management related information of the third-level power consumption management unit 23 and to perform power consumption management on the third-level power consumption management unit 23 according to the acquired information and a preset power consumption management policy.

In an embodiment of the disclosure, the second-level power consumption management unit 22 includes at least one of a baseband processing subsystem power consumption management unit, an application processing subsystem power consumption management unit and an audio subsystem power consumption management unit.

The baseband processing subsystem power consumption management unit is responsible for power consumption management related to communication control and data processing inside the terminal chip.

The application processing subsystem power consumption management unit is responsible for power consumption management related to control and data processing of the application processing subsystem inside the terminal chip.

The audio subsystem power consumption management unit is responsible for power consumption management related to audio control and data processing inside the terminal chip.

In an embodiment of the disclosure, the second-level power consumption management unit includes a baseband processing subsystem power consumption management unit and an application processing subsystem power consumption management unit.

Accordingly, the third-level power consumption management unit under the baseband processing subsystem power consumption management unit includes at least one of a protocol stack kernel unit and a physical layer kernel unit.

The third-level power consumption management unit under the application processing subsystem power consumption management unit includes at least one of an application processor kernel unit and an audio kernel unit.

It should be noted that the embodiment of the disclosure is mainly applied to an SOC. The embodiment of the disclosure implements software-hardware coordination on low-power consumption through a master control ARM kernel and reduces the product realization risk. The power consumption processing of other ARM kernel (stack protocol, physical layer) and ZSP kernel is independent from each other, and there is no mutual influence. Therefore, in no case will some kernels entering a sleeping state make other kernels unable to enter a sleeping state, so that the meaningless increase in power consumption is avoided. The power consumption control mode illustrated in the embodiment of the disclosure is very flexible, brings convenience to the upper-level software scheduling, and is simple in implementation and high in operability. The peripheral of each kernel is controlled by the respective kernel independently, and is no longer processed by a low-power consumption control module. This has advantages that the low-power consumption architecture realizes hierarchical control and it is convenient for software and hardware implementations.

The technical scheme of the disclosure is described below in further detail through specific embodiments.

### Embodiment One

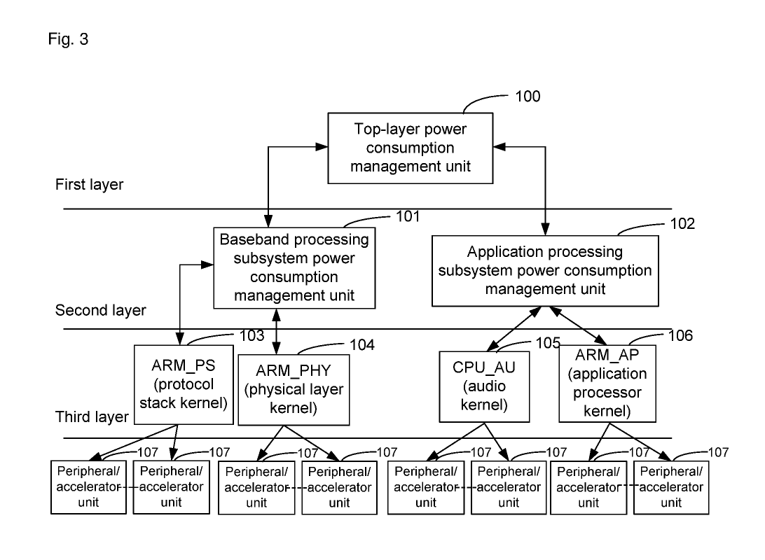

In order to solve the low-power consumption implementation problem of terminal products, under the premise of enhancing system operability, to improve the system performance, greatly reduce hardware implementation resources and overcome the shortcoming of poor performance of existing low-power consumption control methods, an embodiment of the disclosure provides an SOC low-power consumption management scheme; FIG. 3 is a hierarchical diagram of the SOC low-power consumption management in Embodiment One of the disclosure; as shown in FIG. 3, the management system includes a top-layer power consumption management unit 100 (corresponding to the first-level power consumption management unit), a baseband processing subsystem power consumption management unit 101 (corresponding to the second-level power consumption management unit), an application processing subsystem power consumption management unit 102 (corresponding to the second-level power consumption management unit), a protocol stack kernel unit 103 (corresponding to the third-level power consumption management unit), a physical layer kernel unit 104 (corresponding to the third-level power consumption management unit), an audio kernel unit 105 (corresponding to the third-level power consumption management unit), an application processor kernel unit 106 (corresponding to the third-level power consumption management unit), and a peripheral/accelerator unit 107.

Herein, the top-layer power consumption management unit 100 accomplishes the top-layer power consumption management of the entire terminal chip, for example, the power supply control of a Double Data Rate (DDR) synchronous dynamic random access memory, a Phase Locked Loop (PLL), a Voltage Controlled Crystal Oscillator (VCXO), context saving and recovery, and an external Power Management Unit (PMU) chip.

The baseband processing subsystem power consumption management unit 101 accomplishes control and data processing of each communication modem inside the terminal chip, mainly referring to the low-power consumption control of common parts such as the bus, PLL and power supply partition of the base processing subsystem.

The application processing subsystem power consumption management unit 102 accomplishes control and data processing of the application processor subsystem inside the terminal chip, mainly referring to the low-power consumption control of common parts such as the bus, PLL and power supply partition of the application processing subsystem.

The protocol stack kernel unit 103 accomplishes multi-mode (for example, WCDMA/LTE/TD/GSM) protocol stack software processing.

The physical layer kernel unit 104 accomplishes multi-mode (for example, WCDMA/LTE/TD/GSM) physical layer software processing.

The audio kernel unit 105 accomplishes audio playing, post processing and the like.

The application processor kernel unit 106 accomplishes mobile phone application processing such as video processing, game scene processing and photographing.

The peripheral/accelerator units 107 are peripherals (including communication modem module, coprocessor module, image processing module, video processing module, etc.) connected to the units 103, 104, 105 and 106 described in the embodiment of the disclosure; the low-power consumption information of each unit 107 is reported to the unit 103, 104, 105 or 106, and each unit 107 receives a low-power consumption control command from the unit 103, 104, 105 or 106.

The unit 100 conventionally contains a hardware control module (PCU) and a CORTEX-M0 kernel from the ARM cooperation, which achieve the hardware and software control of the top-layer low-power consumption respectively. The CORTEX-M0 kernel may also achieve onsite backup/recovery of the low-power consumption procedure and the low-power consumption control of the external PMU chip. The unit 101, as a baseband processing subsystem management module, plans as a whole the power consumption management of the stack kernel unit 103 and the physical layer kernel unit 104, and performs low-power consumption management on common resources such as internal matrix and PLL of the baseband subsystem. The application processing subsystem power consumption management unit 102 coordinates the power consumption management of the audio kernel unit 105 and the application processor kernel unit 106, and performs low-power consumption management on common resources such as internal matrix and PLL of the baseband subsystem. The stack kernel unit 103 is a multi-mode protocol stack processor, of which power consumption management is performed by the unit 101. The physical layer kernel unit 104 is a multi-mode physical layer processor, of which power consumption management is performed by the unit 101. The audio kernel unit 105 is an audio processor, of which power consumption management is performed by the unit 102. The application processor kernel unit 106 is an application processor, which mainly implements functions such as video, photographing and game, and of which power consumption management is performed by the unit 102. The peripheral/accelerator unit 107 is a peripheral connected to each kernel, and the low-power consumption management thereof is accomplished by respective kernel independently.

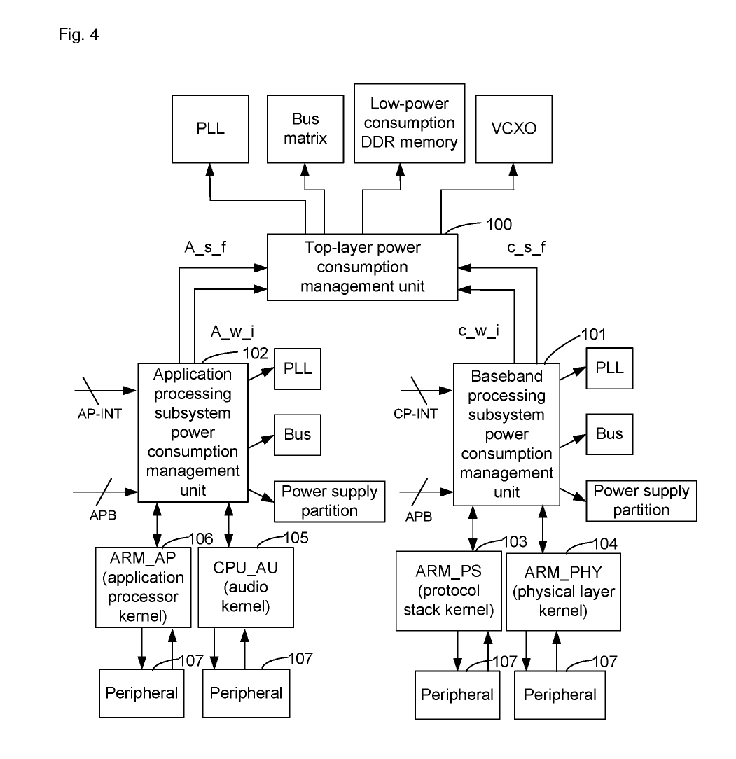

FIG. 4 is a diagram of a preferred embodiment of the SOC low-power consumption management in Embodiment One of the disclosure; refer to FIG. 4, it is supposed that this preferred embodiment is applied to a mobile phone terminal chip and implements low-power consumption control starting from the bottom layer. Specific implementation steps are described below.

First, supposing each peripheral indicated by the units 107 is already in its low-power consumption state and no longer works. The units 107 report the low-power consumption state to the upper-layer processing unit, for example, 103, 104, 105 and 106, and receive low-power consumption instructions from 103, 104, 105 and 106, for example, disable power supply partition, turn off clock and so on.

Second, supposing the peripheral (lte-modem, td-cdma modem, etc.) of the ARM_PHY physical layer processor indicated by the unit 104 is in a low-power consumption state, then the unit 104 may start a sleeping circuit (that is, the Low Power Module (LPM) described in the embodiment of the disclosure) of each modem to record the sleeping time, and then the unit 104 may enter the sleeping state to wait for interruption wakeup. The unit 104 reports the low-power consumption state to the upper-layer processing unit, that is, the unit 101, and receives a low-power consumption instruction from the unit 101, for example, sleeping state indication, sleeping enabling, etc. Supposing the peripheral (High Definition Multimedia Interface (HDMI), Universal Serial Bus (USB), Direct Memory Access (DMA), etc.) of the ARM_AP application processor indicated by the unit 106 is in a low-power consumption state, then the unit 106 may enter the sleeping state to wait the coming of interruption wakeup. The unit 106 can report the low-power consumption state to the upper-layer processing unit, that is, the unit 102, and receives a low-power consumption instruction from the unit 102, for example, sleeping state indication, sleeping enabling, etc. The description for other units 105 and 103 is similar to the above, and the description thereof is omitted here.

Third, supposing as described in the previous step, both the units 103 and 104 have entered respective low-power consumption states and reported the states to the unit 101; the unit 101, as a baseband processing subsystem power consumption control unit, globally manages the protocol stack and physical layer kernels, and peripheral and bus matrix resources thereof. When the unit 101 receives these low-power consumption states, the unit 101 starts the power consumption management of the subsystem, which may control the low power consumption of the PLL and matrix bus AXI corresponding to the subsystem and the power supply partition to which the subsystem belongs, so that the PLL, the matrix bus AXI and the power supply partition enter the power saving state. When an external interruption wakeup comes, the subsystem wakes up the corresponding PLL and matrix bus AXI and the power supply partition to which the subsystem belongs correspondingly, achieving the wakeup operation of the subsystem. After the unit 101 is waken up, the unit 101 feeds back its state to the units 103 and 104, then the units 103 and 104 are waken up (enable clock or power supply partition to which they belong) independently without influencing each other according to the property of interruption wakeup. After the units 103 and 104 are waken up, they feed back their states to their respective corresponding units 107 and wakes up the corresponding units 107, so that the wakeup process of the upper layer and lower layer is accomplished. Likewise, the sleeping wakeup processes of the unit 102 and lower-layer units corresponding to the unit 102 are similar to the above, and thus the description thereof is omitted here. In FIG. 4, A_s_f indicates Ap_sleep_flag, c_s_f indicates cp_sleep_flag, A_w_i indicates Ap_wakeup_int, c_w_i indicates cp_wakeup_int.

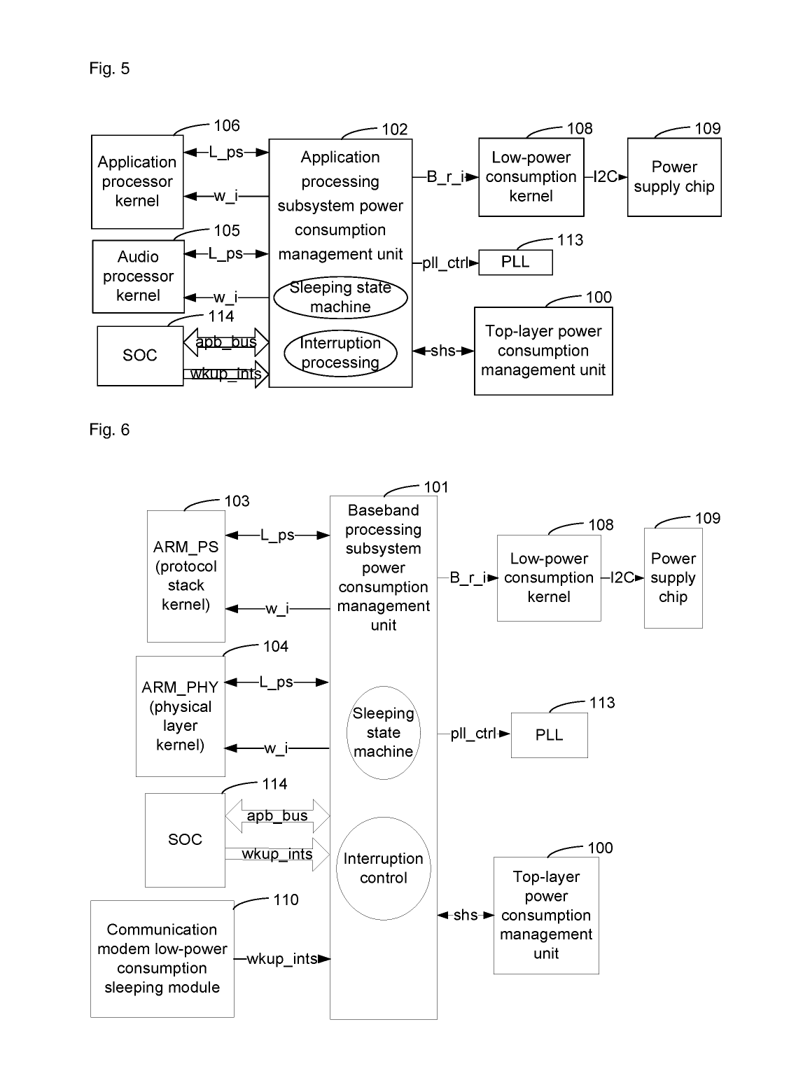

FIG. 5 is a diagram of an application processing subsystem power consumption management unit 102 and peripherals thereof in Embodiment One of the disclosure; FIG. 6 is a diagram of a baseband processing subsystem power consumption management unit 101 and peripherals thereof in Embodiment One of the disclosure; refer to FIG. 5 and FIG. 6, the implementation of this embodiment also involves a unit 108 (CORTEX_M0), a unit 109 (PMIC), a unit 110 (LPM), a unit 111 (LPDDR), a unit 112 (VCXO), a unit 113 (PLL) and a unit 114 (SOC).

The unit 108 (CORTEX_M0) is a micro MCU kernel from the ARM cooperation, and is mainly responsible for the low-power consumption software processing of the chip and the chip boot function.

The unit 109 (PMIC) is an external power supply chip. Different voltages may be supplied to each module of the chip through the unit 109; and the unit 109 supports the Dynamic Voltage and Frequency Scaling (DVFS) low-power consumption technology.

The unit 110 (LPM) is a sleeping module corresponding to a modem of the physical layer; when a corresponding modem is sleeping, the function of this unit is started to perform the sleeping time count and to keep synchronization with the network side.

The unit 111 (LPDDR) is an external storage module connected to the chip, and supports functions such as data caching and onsite saving.

The unit 112 (VCXO) provides a stable low-speed clock for the entire chip, as a reference clock of the PLL 113 inside the chip.

The unit 113 (PLL) is a module providing a high-speed clock inside the chip, and several PLLs may be selected according to the low-power consumption scheme of the chip.

The unit 114 (SOC) refers to a matrix bus and various modules such as a transforming bridge inside the chip.

The unit 114 in the figure, as an SOC unit, controls the bus connection of the entire subsystem, including a configuration bus, an interrupt channel and the like. The units 101 and 102 include an FSM state machine, an interruption control logic (Int ctrl) and may send an interruption to the unit 108 (CORTEX_M0); after the unit 108 receives the interruption, the unit 108 sends an 12C (a bus communication protocol) instruction to control the external unit 109 (PMIC, Power Management Integrated Circuit) to conduct voltage adjustment, thereby achieving the DVFS process, so that each subsystem has different voltages in different scenes and thus the purpose of power saving is achieved. In addition, FIG. 6 contains the unit 110 mentioned above, which records the sleeping time of each modem, keeps synchronization with the network side and sends a wakeup interruption to the unit 101 when the sleeping time expires.

Finally, supposing, as described in the previous step, both the units 101 and 102 have entered their respective low-power consumption states and reported the states to the unit 100; the unit 100, as a top-layer power consumption management unit, globally manages the application subsystem and the baseband processing subsystem, and peripherals and bus matrix resources thereof. When the unit 100 receives these low-power consumption states, the unit 100 starts the top-layer power consumption management, which may control the low power consumption of the corresponding PLL, matrix bus AXI, LPDDR and external VCXO of the top layer, so that the PLL, matrix bus AXI, LPDDR and external VCXO enter the power saving state. When an external interruption wakeup comes, the top-layer power consumption management unit wakes up the corresponding PLL, matrix bus AXI, LPDDR and external VCXO, so that they enable or disable the low-power consumption state in turn, thereby achieving the wakeup operation of the top layer. After the unit 100 is waken up, the unit 100 feeds back its state to the units 101 and 102, then the units 101 and 102 are waken up independently without influencing each other according to the property of interruption wakeup. The wakeup of other layers has been described in the previous step, and thus description thereof is omitted here. In FIG. 5 and FIG. 6, L_ps indicates Low_power signals, w_i indicates wakeup_ints, B_r_i indicates Buck_req_int, shs is an abbreviation of shake hands signals.

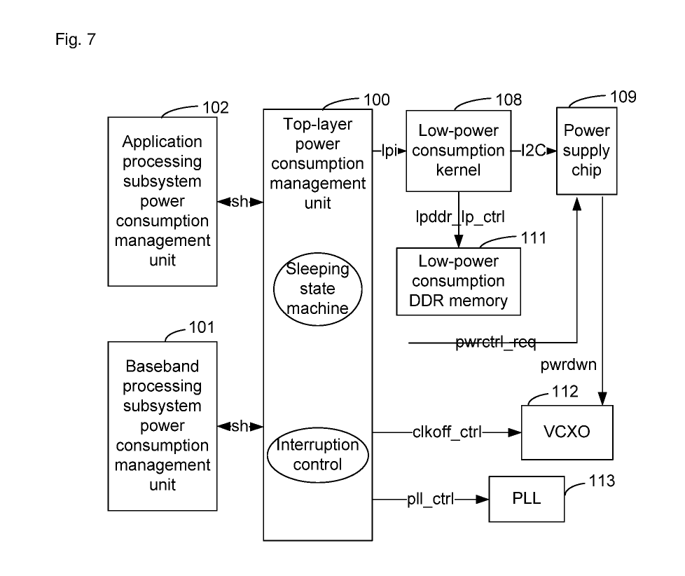

FIG. 7 is an interconnection relationship diagram among a top-layer power consumption management unit 100, a baseband processing subsystem power consumption management unit 101 and an application processing subsystem power consumption management unit 102 in Embodiment One of the disclosure. Referring to FIG. 7, the units 101 and 102 perform signal interaction with the unit 100 through shake hands signals (sleeping state and transmitting instruction), the unit 100 includes an FSM state machine, an interruption control logic and may send interruption to the unit 108 (CORTEX_M0); after the unit 108 receives the interruption, the unit 108 sends an 12C instruction to control the external unit 109 (PMIC, Power Management Integrated Circuit) to conduct voltage adjustment, thereby accomplishing the DVFS process, so that each subsystem has different voltages in different scenes and thus the purpose of power saving is achieved. The unit 108 may also control the unit 113 (LPDDR), so that the unit 113 enters the low-power consumption state, for example, self-fresh, IO_RETENTION and other functions. In FIG. 7, sk is the abbreviation of shake hands, lpi is the abbreviation of low power ints, and l_l_c indicates lpddr_lp_ctrl.

Compared with traditional low-power consumption control methods for a terminal chip, Embodiment One of the disclosure mainly has features as follows.

1. Hierarchical low-power consumption control management is supported; the hierarchical design enables each kernel to directly configure respective corresponding sleeping parameters, so as to accelerate the speed of single-kernel sleeping and wakeup. The baseband processing subsystem power consumption management unit 101 and the application processing subsystem power consumption management unit 102 have respective corresponding controllers (power control units) to perform control. The top-layer power consumption management unit 100 implements the control of common resources such as Matrix, DDR, PLL, SSBUFFER, VCXO and other modules.

2. The top-layer power consumption management unit 100 contains a micro processor CORTEX-M0, and supports the M0 kernel to perform some simple data migration, onsite saving and recovery, software control operation procedure and chip wakeup tasks; the CORTEX-M0 has very low power consumption and has a better effect as a master control kernel.

3. Low-power consumption software-hardware control such as clock gating and power gating of each peripheral, kernel and subsystem of the entire chip is supported.

4. Close cooperation of software and hardware is supported to increase the flexibility and robustness of the low-power consumption procedure.

5. The peripheral 107 of each kernel is controlled by the respective kernel independently, and is no longer processed by the low-power consumption control module, so that the software and hardware interaction between the top layer and the bottom layer is reduced and the complexity of the control procedure is reduced, which facilitates the implementation.

6. The power consumption processing of each ARM kernel 103, 104, 105 and 106 is independent from each other, and there is no mutual influence. Therefore, in no case will some kernels entering a sleeping state make other kernels unable to enter a sleeping state, so that the meaningless increase in power consumption is avoided.

Each of the above units may be implemented by a Central Processing Unit (CPU), a Digital Signal Processor (DSP) or a Field-Programmable Gate Array (FPGA).

The embodiment of the disclosure further provides a computer storage medium, comprising a set of computer executable instructions for executing the power consumption management method described in the embodiment of the disclosure.

Those skilled in the art should understand that the embodiments of the disclosure can provide a method, a system or a computer program product. Thus, forms of hardware embodiments, software embodiments or embodiments integrating software and hardware can be adopted in the disclosure. Moreover, a form of the computer program product implemented on one or more computer available storage media (including, but not limited to, a disk memory, an optical memory and the like) containing computer available program codes can be adopted in the disclosure.

The disclosure is described with reference to flowcharts and/or block diagrams of the method, the equipment (system) and the computer program product according to the embodiments of the disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions assigned in one or more flows of the flowcharts and/or one or more blocks of the block diagrams is generated via instructions executed by the computers or the processors of the other programmable data processing devices.

These computer program instructions can also be stored in a computer readable memory capable of guiding the computers or the other programmable data processing devices to work in a specific mode, so that a manufactured product including an instruction apparatus is generated via the instructions stored in the computer readable memory, and the instruction apparatus realizes the functions assigned in one or more flows of the flowcharts and/or one or more blocks of the block diagrams.

These computer program instructions can also be loaded to the computers or the other programmable data processing devices, so that processing realized by the computers is generated by executing a series of operation steps on the computers or the other programmable devices, and therefore the instructions executed on the computers or the other programmable devices provide a step of realizing the functions assigned in one or more flows of the flowcharts and/or one or more blocks of the block diagrams.

The above are merely preferred embodiments of the disclosure and are not intended to limit the scope of protection of the disclosure.

1. A power consumption management method, applied to a terminal chip, in which at least two levels of power consumption management processors are provided, the method comprising:
acquiring, by an upper-level power consumption management processor, power consumption management related information of a lower-level power consumption management processor; and
performing, by the upper-level power consumption management processor, power consumption management on the lower-level power consumption management processor according to the acquired information and a preset power consumption management policy.

2. The method according to claim 1, comprising: providing a first-level power consumption management processor, at least one second-level power consumption management processor and at least one third-power consumption management processor, wherein
the first-level power consumption management processor performs power consumption management on the second-level power consumption management processor;
the second-level power consumption management processor performs power consumption management on the third-level power consumption management processor; and
the third-level power consumption management processor performs power consumption management on a peripheral of the terminal.

3. The method according to claim 2, wherein the second-level power consumption management processor comprises at least one of a baseband processing subsystem power consumption management processor, an application processing subsystem power consumption management processor and an audio subsystem power consumption management processor, wherein
the baseband processing subsystem power consumption management processor is responsible for power consumption management related to communication control and data processing inside the terminal chip;
the application processing subsystem power consumption management processor is responsible for power consumption management related to control and data processing of an application processing subsystem inside the terminal chip; and
the audio subsystem power consumption management processor is responsible for power consumption management related to audio control and data processing inside the terminal chip.

4. The method according to claim 3, wherein the second-level power consumption management processor comprises a baseband processing subsystem power consumption management processor and an application processing subsystem power consumption management processor, wherein
the third-level power consumption management processor under the baseband processing subsystem power consumption management processor comprises at least one of a protocol stack kernel processor and a physical layer kernel processor; and
the third-level power consumption management processor under the application processing subsystem power consumption management processor comprises at least one of an application processor kernel processor and an audio kernel processor.

5. A power consumption management device, provided in a terminal chip, comprising: a first-level power consumption management processor, at least one second-level power consumption management processor and at least one third-power consumption management processor, wherein
the first-level power consumption management processor is arranged to acquire power consumption management related information of the second-level power consumption management processor and to perform power consumption management on the second-level power consumption management processor according to the acquired information and a preset power consumption management policy; and
the second-level power consumption management processor is arranged to acquire power consumption management related information of the third-level power consumption management processor and to perform power consumption management on the third-level power consumption management processor according to the acquired information and a preset power consumption management policy.

6. The device according to claim 5, wherein the second-level power consumption management processor comprises at least one of a baseband processing subsystem power consumption management processor, an application processing subsystem power consumption management processor and an audio subsystem power consumption management processor, wherein
the baseband processing subsystem power consumption management processor is responsible for power consumption management related to communication control and data processing inside the terminal chip;
the application processing subsystem power consumption management processor is responsible for power consumption management related to control and data processing of the application processing subsystem inside the terminal chip; and
the audio subsystem power consumption management processor is responsible for power consumption management related to audio control and data processing inside the terminal chip.

7. The device according to claim 6, wherein the second-level power consumption management processor comprises a baseband processing subsystem power consumption management processor and an application processing subsystem power consumption management processor, wherein
the third-level power consumption management processor under the baseband processing subsystem power consumption management processor comprises at least one of a protocol stack kernel processor and a physical layer kernel processor; and
the third-level power consumption management processor under the application processing subsystem power consumption management processor comprises at least one of an application processor kernel processor and an audio kernel processor.

8. A non-transitory computer storage medium, comprising a set of computer executable instructions for executing a power management method, the method comprising:
acquiring power consumption management related information of a lower-level power consumption management processor; and
performing power consumption management on the lower-level power consumption management processor according to the acquired information and a preset power consumption management policy.

9. The non-transitory computer storage medium according to claim 8, comprising: providing a first-level power consumption management processor, at least one second-level power consumption management processor and at least one third-power consumption management processor, wherein
the first-level power consumption management processor performs power consumption management on the second-level power consumption management processor;
the second-level power consumption management processor performs power consumption management on the third-level power consumption management processor; and
the third-level power consumption management processor performs power consumption management on a peripheral of the terminal.

10. The non-transitory computer storage medium according to claim 9, wherein the second-level power consumption management processor comprises at least one of a baseband processing subsystem power consumption management processor, an application processing subsystem power consumption management processor and an audio subsystem power consumption management processor, wherein
the baseband processing subsystem power consumption management processor is responsible for power consumption management related to communication control and data processing inside the terminal chip;
the application processing subsystem power consumption management processor is responsible for power consumption management related to control and data processing of an application processing subsystem inside the terminal chip; and
the audio subsystem power consumption management processor is responsible for power consumption management related to audio control and data processing inside the terminal chip.

11. The non-transitory computer storage medium according to claim 10, wherein the second-level power consumption management processor comprises a baseband processing subsystem power consumption management processor and an application processing subsystem power consumption management processor, wherein
the third-level power consumption management processor under the baseband processing subsystem power consumption management processor comprises at least one of a protocol stack kernel processor and a physical layer kernel processor; and
the third-level power consumption management processor under the application processing subsystem power consumption management processor comprises at least one of an application processor kernel processor and an audio kernel processor.
